(19) United States
(12) Patent Application Publication
(10) Pub. No.: US 2005/0192816 A1
(43) Pub. Date: Sep. 1, 2005

(54) Systems and methods for managing product returns using return authorization numbers

(75) Inventor: Hilmar Wechsel, Leimen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SAP Aktiengesellschaft

(21) Appl. No.: 10/787,205

(22) Filed: Feb. 27, 2004

(51) Int. Cl. G06F 17/60

(52) U.S. Cl. 705/1

(57) ABSTRACT

Systems and methods are disclosed for managing product returns. In one embodiment, when a request from a customer to return a product is authorized, a record in each of a plurality of systems for managing the product return is created and a unique identifier is assigned to the product return. The unique identifier may then be associated with each record corresponding the product to be returned and, thereafter, information regarding the product return may be exchanged between the plurality of management systems utilizing the unique identifier.

### BACKGROUND OF THE INVENTION

I. Field of the Invention

The present invention generally relates to systems and methods for managing product returns. More particularly, the present invention relates to systems and methods for managing product returns by using unique identifiers that serve as control instruments for handling the returns.

II. Background Information

Software and computer-implemented management systems have not only become commonplace, but are nearly indispensable to businesses large and small. For example, in sales, such systems may be used to manage the various aspects of a sale, from customer account information to inventory, product movement, scheduling, and shipping information. While these systems are often quite efficient for tracking sales information and managing customer accounts, they are often inefficient in tracking other information necessary for the accurate resolution of returns.

More specifically, there is a problem in the art in that products and other items returned from customers must be accurately tracked and resolved. Such tracking involves the exchange of information between various entities and/or employees, such as shipping companies, warehouse employees, and account managers. Such entities must work together to insure, for example, that the return is authorized, has been received back from the customer and is not damaged, among other things. In addition, upon receipt and processing of a returned product, the supplier to whom the product is returned, must determine how to dispose of the product (e.g., repair, resell, reshelve, etc.) and how to account for the product in the specific customer's account (i.e., credit, replace, reimburse, etc.). Efficient and accurate accounting of this information requires proper handling of the return and communication between the different software packages and computerized management systems, which, to date, is unavailable.

### SUMMARY OF THE INVENTION

Consistent with embodiments of the present invention, systems and methods are disclosed for managing product returns. In one embodiment, to handle returned products using a plurality of management systems, a unique identifier is assigned to each product return. This unique identifier may take any form, such as a return authorization number (RAN). The unique identifier or RAN may be used by the plurality of management systems to exchange information and efficiently handle returns from customers.

In accordance with another embodiment, a method for managing a product return consistent with the invention includes: authorizing a request from a customer to return a product; creating at least one record in each of a plurality of management systems for handling the product return that is authorized; assigning a unique identifier to the product return; associating the unique identifier with each record corresponding to the product to be returned; and exchanging information regarding the product return between the plurality of management systems utilizing the unique identifier.

According to still another embodiment, a method for managing a product return consistent with the invention comprises: receiving at a first database a return request for the product; issuing from the first database a return authorization number (RAN) for the product if the return is authorized; creating a record in a second database corresponding to the return, the record comprising the RAN; and updating the record in the second database after the product has been returned.

In accordance with yet another embodiment, a method for managing a product return consistent with the invention comprises: assigning a return authorization number (RAN) to an approved product return; creating in a first management system a return authorization record for the approved product return comprising the RAN; creating in a second management system a warehouse record comprising the RAN; and updating the return authorization and the pending delivery records using the RAN. In the exemplary method, the first management system may include a customer relationship management (CRM) system, and the second management system may include a supply chain management (SCM) or warehouse management (WM) system.

According to still another embodiment, a computer readable medium containing instructions for carrying out a method for managing a product return is provided. Consistent with the invention, the method comprises: indexing a record in a first database for a product return using a return authorization number; creating a record for the product return in a second database, comprising a return authorization number; and exchanging between the first and second database information related to the product return, wherein each item of exchanged information is identified by the return authorization number.

Embodiments of the invention are also directed to systems for managing product returns. For instance, in accordance with one embodiment, a system for managing a return of a product comprises: a customer relationship management (CRM) system configured to receive a return request for the product and to generate a first record comprising a return authorization number (RAN) for the product if the return request is authorized; and a warehouse management (WM) system, in communication with the CRM system, configured to create a second record corresponding to the return, the second record comprising the RAN, wherein the CRM and WM systems are each configured to exchange information regarding the return utilizing the RAN.

According to still another embodiment, a system for managing a product return consistent with the invention may comprise: a computer configured to assign a return authorization number (RAN) to a product return; and a plurality of management components, each configured to receive the RAN and to create at least one record corresponding to the product return, wherein each record corresponding to the return item is uniquely associated with the RAN.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary environment including a customer and a supplier of products, consistent with the present invention;

FIG. 2 is a flowchart depicting an exemplary method for managing product returns from customers, consistent with an embodiment of the invention;

FIG. 3 is a flowchart depicting another exemplary method for managing product returns from customers, consistent with an embodiment of the invention;

FIG. 4 illustrates an exemplary data structure for communicating information between a plurality of management systems, such as between a customer relationship management (CRM) system and a warehouse management (WM) system;

FIG. 5 illustrates an exemplary embodiment, consistent with the invention, for using a return authorization number (RAN) as a unique identifier for return authorizations and warehouse management requests; and

FIG. 6 illustrates an exemplary embodiment, consistent with the invention, of splitting a Warehouse (WH) Request while maintaining RAN(s) to manage the returned items.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

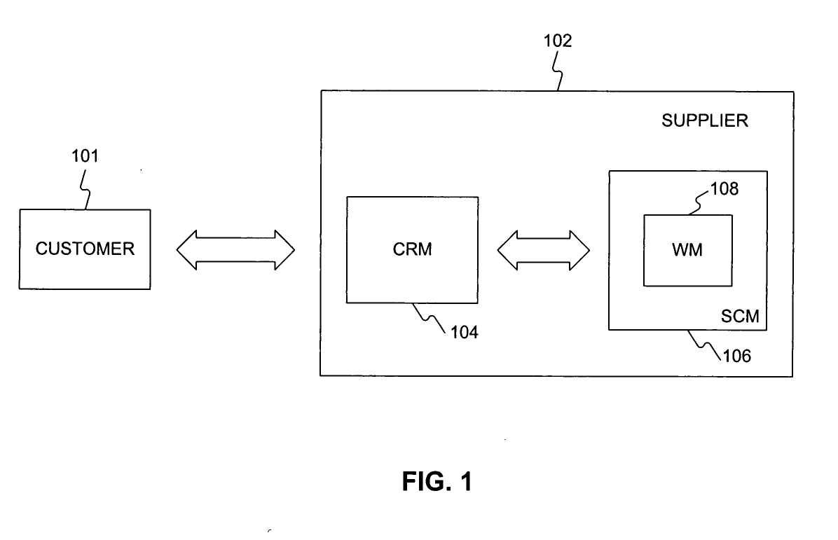

FIG. 1 illustrates an exemplary environment, consistent with the invention, that includes a customer 101 and a supplier 102. As will be appreciated from the teachings hereof, FIG. 1 provides a practical example of an environment in which embodiments of the invention may be implemented.

In the block diagram of FIG. 1, a buyer-seller relationship or similar arrangement is depicted between customer 101 (the “buyer”) and supplier 102 (the “seller”) of products. As used herein, the term “product” refers to any good, item or merchandise supplied or sold by supplier 102. By way of example, a product may be a finished product or may be any part or item used for manufacturing or providing a finished product. A product may also be any good or item for providing services to other customers.

In the example of FIG. 1, customer 101 refers to any entity who purchases or otherwise receives a product from supplier 102. By way of example, customer 101 may be any entity, such as an individual consumer or a business entity such as a manufacturer, a dealer (e.g., an automotive dealer) or a supplier who purchases products from supplier 102 for future resale or transfer to another party. Supplier 102 may be any entity, such as an individual or business entity, who sells or otherwise provides products or goods to a customer, such as customer 101. As will be appreciated by those skilled in the art, more than one customer or supplier may exist, depending on the number and type of buyer-seller relationships formed. For example, in one embodiment, supplier 102 may sell or provide products to a plurality of customers.

As shown in FIG. 1, supplier 102 may have one or more management systems or modules 104 and 106. These management systems may be implemented with any suitable combination of computer hardware, software and/or firmware to manage and process data relevant to interactions with customer 101 and/or the sale or distribution of products. For example, customer relationship management (CRM) module 104 may be used to manage all processes and information involving the customer throughout the entire customer relationship life cycle, from market segmentation, sales lead generation and opportunities, to post-sales and customer service. CRM 104 may also managevarious business scenarios such as field sales and service, Internet sales and service, and direct customer interactions.

CRM 104 may be in electronic communication with one or more other management systems of supplier 102, such as a supply chain management (SCM) module 106. SCM 106 may manage the various aspects of a supply chain, including, but not limited to, inventory, product movement, and scheduling of product shipping. As will be appreciated by those skilled in the art, CRM 104 or SCM 106 may include one or more subcomponents. For example, FIG. 1 shows warehouse management (WM) module 108 as a subcomponent of SCM 106 to manage information related to one or more warehouses, such as shipping, receipt of parts, and/or inventory levels.

In one embodiment, CRM 104, SCM 106 and WM 108 are implemented as software modules or components and capable of performing the functions and tasks disclosed herein. Additionally, or alternatively, CRM 102, SCM 106, and WM 108 may be implemented with or include one or more database(s), such as relational databases, designed, maintained, and operated in accordance with the teachings hereof. In one embodiment, a centralized database is used for all management systems of supplier 102. In another embodiment, individual databases are provided for storing data relevant to each management system (e.g., CRM 104 and SCM 106/WM 108). If CRM 104, SCM 106 and WM 108 are implemented using a plurality of software modules and/or databases, the various software modules and/or databases may be in electronic communication with each other for the purpose of passing information back and forth. Such communication may be accomplished over conventional wired and/or wireless networks using, for example, a web (Internet) gateway or portal, e-mail, an electronic data interchange (EDI), an open-interface such as a Basic Application Interface (BAPI), XML, and/or any other known or later developed electronic messaging protocols or systems.

In one embodiment, CRM 104, SCM 106 and WM 108 are integrated and operate within a common platform. Such a platform may provide easy integration of additional components and/or a standard communication format for communication among the various software components or modules. One example of such a platform is the R/3 system available from SAP AG (Walldorf, Germany). In an R/3 system, “information objects” may be employed to pass information from one integrated component or module to another.

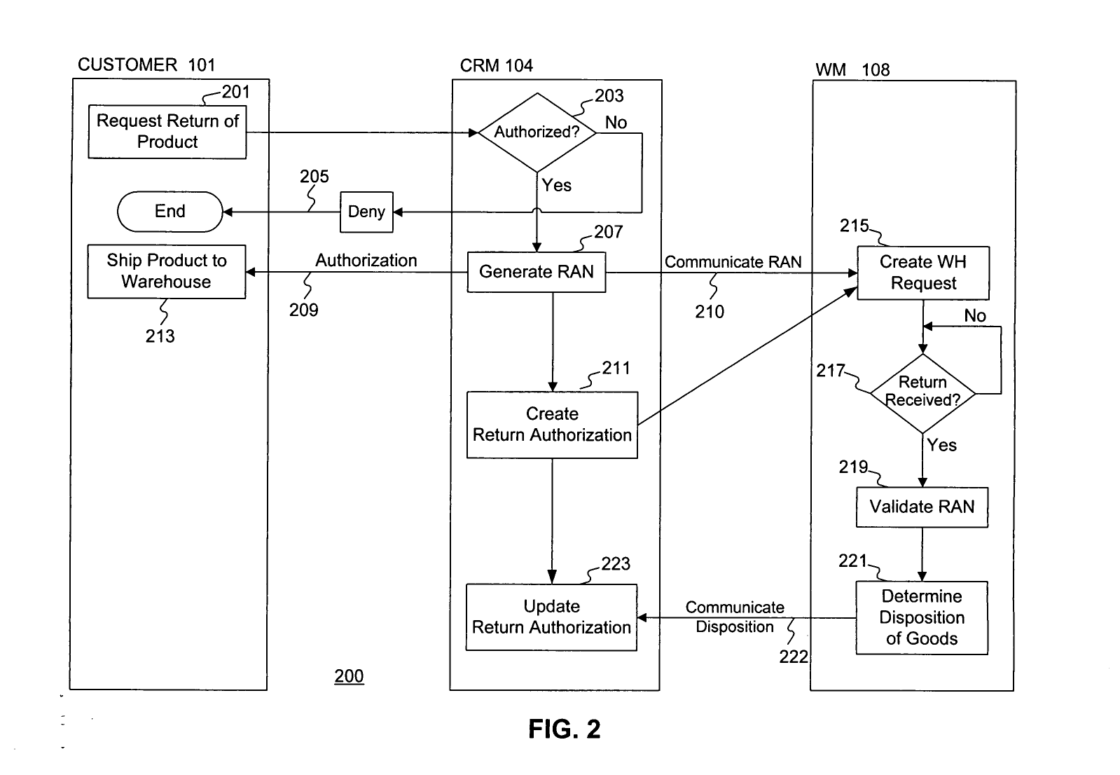

Referring now to FIG. 2, an exemplary method 200 is provided for managing product returns from customers, such as customer 101. As shown in FIG. 2, method 200 may begin when customer 101 requests authorization for a product return, step 201. The return request may contain various information, such as the customer's ID or account data, the product type and quantity, the reason for the return (damaged, wrong product, etc.), and/or the customer's expectation (refund, credit, replace, etc.). While the customer's request may provide all relevant return information, alternatively, any part of the return information may be determined by supplier 102 (CRM 104) by, for example, obtaining relevant information from its records or sales databases. Customer 101 may communicate the return request to supplier 102 via any known method, including, but not limited to, telephone, standard mail, email, fax, and web (Internet) portal or gateway.

Upon receipt of the return request, supplier 102 determines if customer 101 is authorized to return the product, step 203. Such a determination may be made by CRM 104 based on various criteria, such as the terms, conditions, or requirements of a sales contract or the customer's status. If customer 101 is not authorized to return the product (step 203; No), then supplier 102 will deny the request, step 205 and, thereafter, process 200 will end. In one embodiment, the denial of a return request is communicated to customer 101 by CRM 104 using suitable communication means (telephone, standard mail, email, fax, a web (Internet) portal or gateway, etc.).

If, however, the customer is authorized to return the part (step 203; Yes), supplier 102 will generate a unique identifier for the return, step 207. The unique identifier may be generated by CRM 104 and take various forms. In one embodiment, a unique identifier in the form of a return authorization number (RAN) is generated. As further disclosed herein, the RAN may be assigned to each return authorization item on a return-item-level basis.

Consistent with the invention, the RAN may be numeric, alphanumeric, or alphabetic, or any unique combination of symbols capable of functioning as a unique identifier. Furthermore, the RAN may be randomly assigned, or may be built from a one or more identifying codes including, but not limited to geographic codes, dealer customer codes, product codes, return codes, and/or dates. In one embodiment, the RAN is a unique identifier for the returned product and exchanged with each parcel or combination of information in supplier 102's management modules, to allow for accurate and efficient tracking of information related to the product return.

The approval of the return request may trigger other actions, such as the creation of a Return Authorization, step 211. The Return Authorization may be a data structure, record, or file (such as an information object in an R/3 system) that stores information about the product return, including, but not limited to, the type of product being returned, the quantity to be returned, shipping information, and/or state of the request. Further, the Return Authorization may include the unique identifier or RAN associated with the product return and represent that a return request has been authorized/approved by supplier 102.

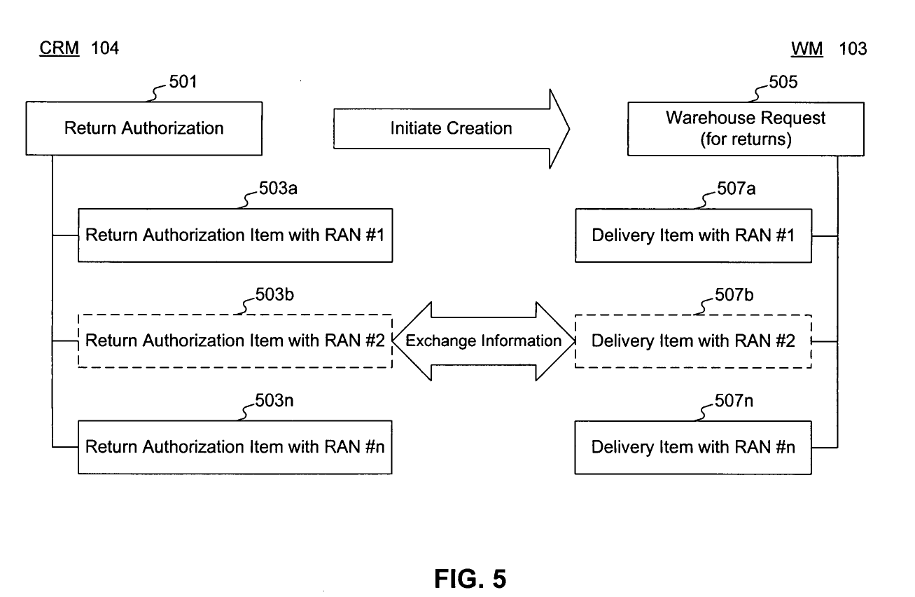

The specific structure of the Return Authorization is not critical to the invention and, as will be appreciated from the disclosure hereof, various embodiments of the Return Authorization are possible. By way of example, a Return Authorization may be created for each return request. Further, in order to accommodate return requests that are submitted for a plurality of different types of products or items, the Return Authorization may be structured with one or more Return Authorization Items (see, for example, FIG. 5). Each Return Authorization Item may represent an approved return for a specific type of product or item. Information contained in a Return Authorization Item may include, but is not limited to, the assigned identifier or RAN for the product return, as well as the product type (or material number) and a quantity of the product return. In one embodiment, each Return Authorization Item contains a RAN that is unique to the specific type of product or item that is approved for return. Thus, if a return request is made for three different types of products, a RAN may be created for each of the different product types (i.e., RAN#1, RAN#2, RAN#3) when the return request is authorized.

Referring again to FIG. 2, upon approval of the return request, an authorization, including the RAN, is sent to customer 101, step 209. In one embodiment, the authorization includes a shipping notification. The shipping notification may include a mailing label created by supplier 102. The shipping label may contain the RAN and the address to which to ship the returned product(s). The shipping notification may be communicated to the customer via any communication means, such as standard mail, email, fax, a web (Internet) portal or gateway, etc.

When a RAN is generated by CRM 104 for a product return (step 207), the RAN is communicated to other management systems, such as WM 108, step 210. Upon receipt of the RAN, WM 108 may create a data structure, record, or file for each product return, step 215. By way of example, a data structure, record, or file (such as an information object in a R/3 system) may be created to provide a Warehouse (WH) Request. The WH Request may be used for managing and tracking product returns at the warehouse level. Additionally, the WH Request may provide a data structure for storing information related to any other request (such as inbound and/or outbound requests) related to a warehouse.

In one embodiment, each WH Request may contain information concerning the delivery of a product return from a customer. Such information may include, but is not limited to, the type of product being returned, the quantity of items to be returned from the customer, a return code, etc. Further, as indicated above, the WH Request may include the unique identifier or RAN associated with the product return.

As with the Return Authorization, the exact structure of the WH Request is not critical to the invention. Therefore, various embodiments of the WH Request may be implemented, consistent with the invention. By way of example, WH Requests may be created for each authorized return request. In addition, since some return requests will include a number of different products or items to be delivered to the warehouse, the WH Request may be structured with one or more Delivery Items (see, for example, FIG. 5). Each Delivery Item may represent an approved return for a specific product type. Information contained in a Delivery Item may include, but is not limited to, the assigned identifier or RAN for the product return, as well as the product type and quantity to be returned and delivered to the warehouse.

As further disclosed herein, in follow-up processes, the RAN can be used as a unique identifier to facilitate the accurate transfer of data from the WH Request (in WM 108) to the Return Authorization (in CRM 104) and vice versa.

When the product return has been authorized, customer 101 may ship the product(s) together with the shipping notification or label back to the supplier, step 213. In one embodiment, customer 101 uses the shipping label, containing the RAN, forwarded by supplier 102, or CRM 104. One of ordinary skill in the art will recognize the use of this embodiment can be beneficial because the RAN appears on the exterior of the package making scanning and identification by warehouse workers easier upon receipt of the returned product. However, it is not necessary that the RAN appear on the exterior of the package. For example, other codes or indicia on the package (such as bar codes or other indicia) may be scanned and used to identify the corresponding RAN and/or WH Request.

In another embodiment, the return of the product may be handled by a third-party, courier or shipping company, such as Federal Express™. In such a case, either the RAN or the shipping notification information may be communicated to a shipping company for inclusion on the shipping label. Integration of the shipping notification with a third-party shipper in this manner allows for tracking of the product during its shipment to supplier 102.

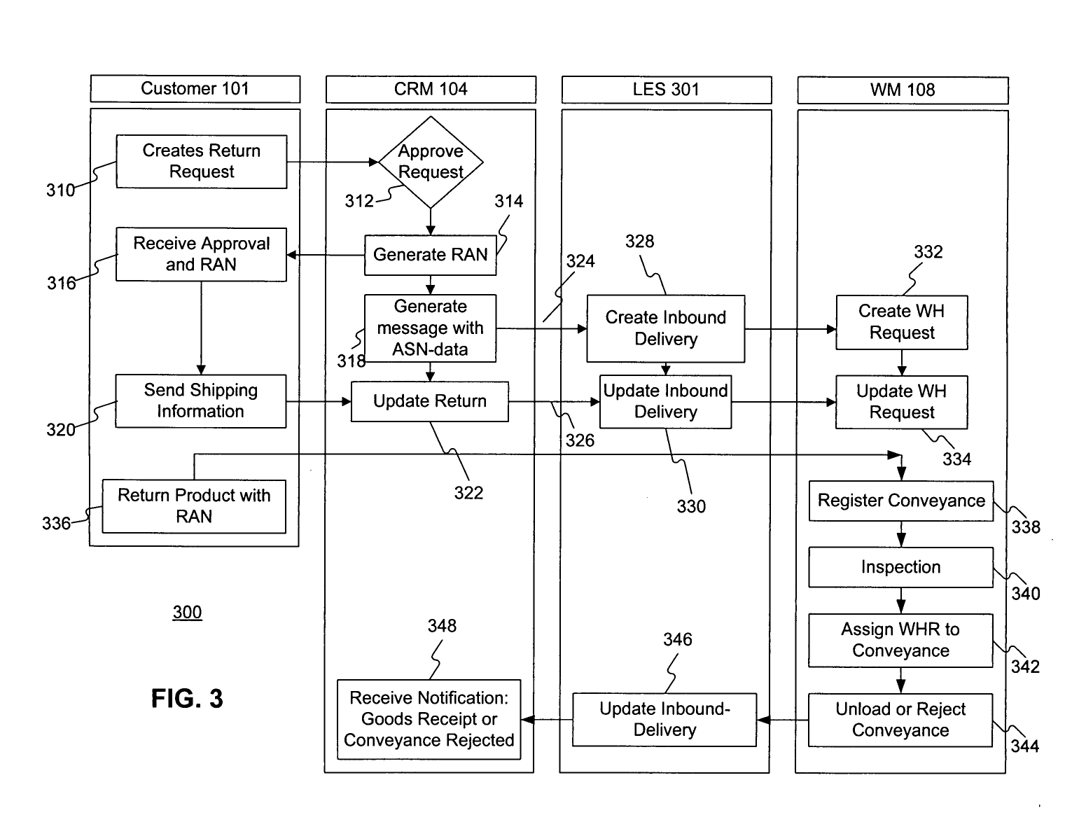

Product deliveries to the warehouse may be inspected to determine if the product return has been received from the customer, step 217. For example, upon receipt of products at the warehouse, supplier 102 may verify that the received goods are identified by a RAN. Upon verification of the existence of the RAN, WM 108 may verify the validity of the RAN, step 219, by searching a database for the pending delivery (e.g., the WH Request) containing the RAN marked on the returned product, and determining if the product type and/or quantity listed in the pending delivery match the returned item(s). Once the goods have been matched to a pending delivery, WM 108 may then update its information concerning the return (i.e., the return has been received), and then inspect the returned products to determine how to dispose of the goods, step 221. For example, the inspection of the returned items may result in various dispositions, such as reselling them, refurbishing them, issuing credit to customer 101, etc. Exemplary systems and methods for inspecting return goods and communicating the disposition of the goods through decision codes are the subject of U.S. application [Attorney Docket No. 08020.0012] filed concurrently herewith. Such features may be used in combination with the teachings hereof. In either case, the disposition may be communicated by CRM 104 (step 222) and used to update the records of the return, such as the Return Authorization in CRM 104 (step 223). FIG. 3 illustrates another exemplary method 300 for managing product returns, consistent with the present invention. As shown in FIG. 3, the exemplary method may be performed in an environment including customer 101, CRM 104, and WM 108, each of which have been described above. Further, in the embodiment of FIG. 3, an additional component, a Logistics Execution and Shipping (LES) module 301, is shown. Consistent with the present invention, LES 301 is a module that manages all deliveries (Inbound/Outbound) and delivery procedures (like calling an ATP check). LES 301 may also provide an interface between different management systems, such as CRM 104 and WM 108. As with CRM 104 and WM 108, LES 301 may be implemented as a software-based module or component. By way of example, LES 301 may be implemented as a logistics execution and shipping (LES) module in an R/3 system.

Method 300 begins when customer 101 creates a return request and sends it to CRM 104, step 310. The return request need not contain all information about the return, but instead, the information may be later updated within CRM 104, as discussed below. For example, the customer need not include details about the product or the quantity in the return request at step 310. Instead, the return request need include only the information sufficient for supplier 102 to determine if the return is authorized.

Upon receipt of the return request, CRM 104 may either approve or reject the request, step 312, depending on the sales contract or other relationship formed between the customer and supplier. In case of approval, CRM 104 generates a return authorization number (RAN), step 314, and communicates the RAN to the customer, step 316. The return request and the RAN may be communicated between customer 101 and CRM 104 in any of the ways discussed above with regard to FIG. 2. Preferably, customer 101 receives this information via email or at a web site or portal designed for this purpose. For example, upon entry of a return request, a web server hosting the site may forward the request to CRM 104 for approval. If the return request is approved, the RAN generated by the CRM 104 may be forwarded and displayed to the customer via the web site. The customer may then either print out or otherwise copy the RAN for use in the return process. Additionally, or alternatively, the web site may generate a shipping label including the RAN, for customer 101 to print out and use for shipping the product return.

Also, upon authorization of the return request, CRM 104 may generate a message with Advance Shipping Notice (or Notification) (ASN) data, step 318. The ASN is a notification of the anticipated arrival of goods shipped, and may contain such information as the anticipated delivery date, quantities, product types, details of the return and/or the RAN associated with the return. The ASN may also take the form of a Return Authorization as discussed above with regard to FIG. 2.

In one embodiment, if customer 101 has not provided all information about the return in the return request (step 310), the customer may communicate any remaining information to CRM 104, step 320, to allow for the update of the return in CRM 104, step 322. When updating the return information in this way, it is preferable to include the RAN with the remaining information to allow the information to be properly identified and associated with the appropriate record in CRM 104.

The ASN is sent to the WM 108 via the LES 301 (step 324) using communication protocols and systems such as an EDI, email, fax or other communication means. Upon updating of the Return in CRM 104 (step 322), the update may also be communicated to LES 301 (step 326) and WM 108 (step 334). One of ordinary skill in the art will recognize that steps 324 and 326 may be combined such that the ASN-data are only communicated once they have been updated (step 322). In addition, while CRM 104 may communicate the ASN-data (and the updates) to both WM 108 and LES 301, it is also within the scope and spirit of the present invention to communicate it to only one of these modules (e.g., LES 301) and to be echoed from that module to the remaining module(s).

The receipt of the ASN-data by LES 301 triggers the creation of the inbound-delivery in LES 301 (step 328) which may be updated (as discussed above) at step 330. ASN-data is all data, contained in an advanced shipping notification (ASN), such as the anticipated delivery date, the quantities, and details of the materials (and/or services). The inbound-delivery created at step 328 may contain the ASN-data, provided by CRM 104, but may also contain additional ASN-data (such as via the update, step 330) received and identified with the appropriate inbound-delivery by the return authorization number (RAN). Other data (e.g., conveyance-ID, bill of lading number) may also be captured later manually.

The creation of the inbound-delivery also initiates the creation of a return WH Request in WM 108, step 332. In addition to the creation of the delivery request, it is possible to receive the ASN-data in the follow ways:
Customer 101 sends the shipping information to CRM 104. CRM 104 triggers the automatic update of the ASN-data in LES 301 and provides the relevant ASN-data from the shipping information. For example, customer 101 informs CRM 104 about the final quantity of a material, to be returned, which may be different than the approved quantity. CRM 104 sends the ASN-data to LES 301, which updates the inbound-delivery with the changed quantity. In this case, it is not required to generate a separate ASN.
Customer 101 sends a separate ASN (e.g., via EDI). This ASN will be received and stored as a document in LES 301. The data from this ASN updates the data in the related inbound-delivery.
The carrier (not shown) sends an ASN (e.g., via EDI). This ASN will be received and handled in the same way as the ASN from the customer.
In case that the conveyance arrives at the warehouse and no related WH Request exists, WM 108 may trigger the creation of an inbound-delivery and the corresponding WH Request.

Customer 101 may, after receipt of the RAN, utilize the shipping information and the RAN to send the product return back to the warehouse (step 336). Upon receipt at the warehouse, the product will be registered, to acknowledge in WM 108, that it has been received (step 338). An inspection in the yard or at the dock can be carried out to decide whether to unload the conveyance or to reject it back to customer 101 (step 340). The return may then be matched with the appropriate WH Request in WM 108 (step 342).

In case of rejection of the conveyance, the WH Request will be updated by WM 108 (not shown) and the inbound-delivery will be updated by LES 301 (step 346) to reflect that the return was rejected. Also, CRM 104 will be notified about the rejected conveyance (step 348) to allow for proper management of the clients account to reflect the disposition of the returned good.

One of ordinary skill in the art will recognize that a RAN, as created and used in the exemplary methods 200 and 300, allows for the efficient and accurate tracking of information between the various management systems or databases used to track and manage product returns. Once created and assigned to a Return Authorization item in CRM 104, and to a WH Request in WM 108, all updates and new information may be passed between WM 108 and CRM 104, using the RAN as an index to identify the proper records for updating. Use of the RAN need not be limited to WM 108 and CRM 104, but, instead, the RAN may be used as an index to other management systems or databases, consistent with the principles of the present invention, to provide a unique identifier and achieve similar data communication therebetween. In this manner, following inspection and disposition of the return goods, warehouse management WM 108 may communicate with CRM 104 to permit efficient management of a customer account and crediting of goods.

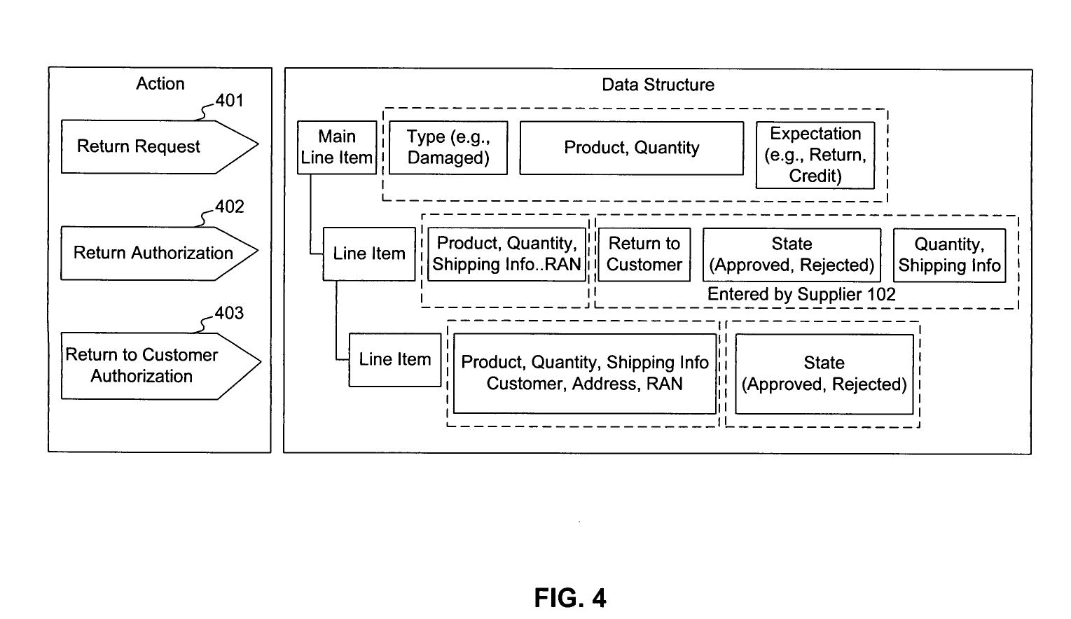

FIG. 4 illustrates an exemplary data structure for communicating information between a plurality of management systems, such as between a customer relationship management (CRM) system and a warehouse management (WM) system. The data structure of FIG. 4 may be used in combination methods for managing product returns, such as the exemplary methods 200 and 300 of FIGS. 2 and 3.

As illustrated in FIG. 4, the exemplary data structure may take the form of a line item structure that is populated with various data based on a plurality of action items. With a line item structure, a data record may be created to track various types of product returns, including return requests involving a number of different product types. Return Request 401 is the request from a customer to return something (e.g., material 1418 with quantity 10). Return Request 401 may contain just one material. If the customer wants to return a second material, the customer may create a second request. This second request will be an additional main line item. If the request is approved, the Return Authorization 402 (a sub line item) will be created and attached to Return Request 401. Additional sub-line items may be attached to Return Authorization 402. For example, invoice requests may be milestones at which a customer (such as a parts dealer) gets back a certain amount of money for the returned product. Authorization 403 (a sub line item) may be created after the inspection occurs in the warehouse or storage facility. Authorization 403 is an example for the situation that a material is in bad condition and should be rejected to a dealer. Therefore, Authorization 403 is labeled as “Return to customer” in FIG. 4. In other examples, this sub-line item could be “Scrap material” or “Stock movement”.

In one embodiment, when a return request 401 is made by a customer and a return authorization 402 is generated, the data structure may be created (e.g., by CRM 104) to serve as a data record for the product return. Based on the return request, the data structure may be populated with data for a main line item. That data may include: the type or reason for the return (e.g., “incorrect product” or “damaged”); the product type(s) and quantities; and the customer's expectation for the disposition of the return (e.g., return, credit, replace, etc.). One or more line items may also be generated, with each line item including, for example, the specific product type, quantity and associated RAN. As further actions occur (such as actions 403 and 404), additional data may be populated in the line items and/or data may be updated.

In one embodiment, the use of unique RANs permit the efficient management of return requests from customers that involve the return of several different items (products) in the same request. In addition to the embodiment of FIG. 4, an exemplary embodiment is illustrated in FIG. 5 for using RANs as unique identifiers for return authorizations and warehouse management requests. In FIG. 5, a conceptual diagram of a Return Authorization 401 is provided. Return Authorization includes a plurality of Return Authorization Items 503a, 503b . . . 503n, wherein each return authorization item corresponds to a specific product type to be returned. As discussed above, each return authorization item may contain at least the product type, quantity to be returned and the RAN for the product to be returned. In the case where there are more than one product to be returned, the multiple Return Authorization Items 503a, 503b . . . 503n corresponding to the same customer return request are packaged together as a single Return Authorization 501. In this case, the creation of Return Authorization 501 triggers the creation of a WH Request 505, consisting of Pending Delivery Items 507a, 507b, . . . 507n corresponding to respective Return Authorization Items 503a, 503b . . . 503n.

For purposes of illustration, assume a return authorization request is sent to the supplier requesting the return of five soda bottles and two apple juice bottles. A first RAN (“RAN A”) will be generated by CRM 104 and assigned to the five soda bottles. A second RAN (“RAN B”) may be generated by CRM 104 and assigned to the two apple juice bottles. Together RAN A and RAN B will form a Return Authorization. This Return Authorization will trigger the creation of a WH Request having two Delivery Items, one for the soda bottles (with RAN A) and one for the apple juice bottles (with RAN B). Configuring the Return Authorization and Warehouse Management requests in this way will allow the WM 108 and CRM 104 to independently maintain the information for each item. For example, the apple juice bottles may not be received at the same time as the soda bottles, may be damaged, or may not be subject to the same credit policy in the CRM, requiring different handling in either WM 108 or CRM 104.

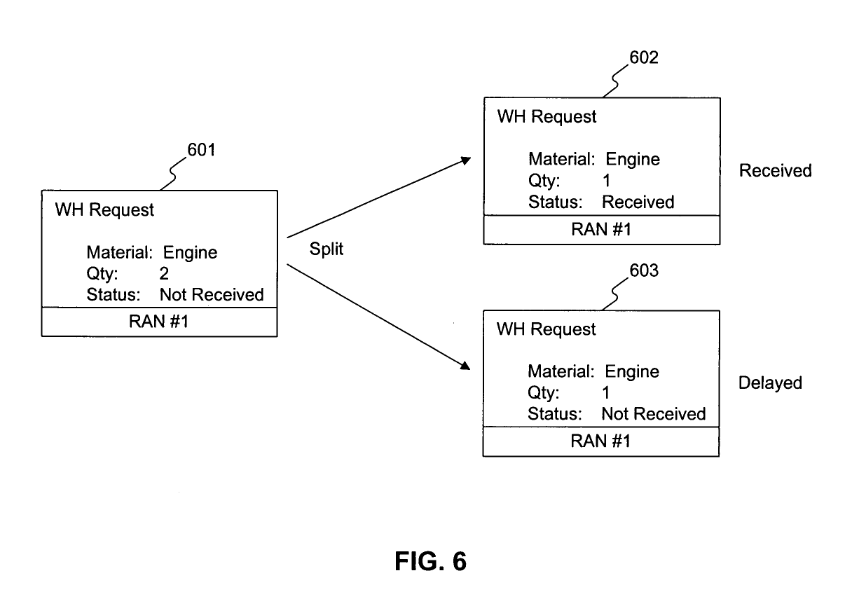

In accordance with another embodiment, the RAN may be used to track product returns at the warehouse level when the full quantity to be returned from the customer is not returned at the same time. For example, the WM 108 may split a WH Request to create two new WH Requests; one possibly for material shipped and received and the other possibly for material that could not be returned at the same time. FIG. 6 graphically depicts the split of a WH Request for efficient management of this scenario. Assume, for example, that WH Request 601 is associated with a request to return two engines of the same type, to which RAN #1 has been assigned. When only one engine is received from the customer, WH Request 501 may be split into a WH Request 602 for the received engine and a WH Request 603 for the second engine, which has been delayed. Each of WH Requests 602 and 603 is still assigned RAN #1, however, each request will identify a different status and quantity for the return. Accordingly, by searching for RAN #1, and status: “not received,” the RAN permits efficient searching for the outstanding WH Request. Upon receipt of the second engine, WH Requests 602 and 603 may be re-combined into a single WH Request, and updated to reflect receipt of all outstanding product returns (not shown). Using the RAN in this manner, the requests may be indexed and linked together to allow warehouse management personnel to identify and efficiently track product returns. Furthermore, use of the RAN in this example permits WM 108 to communicate to CRM 104 that only one of the two items has been received.

While certain features and embodiments of the invention have been described, other embodiments of the invention will be apparent to those skilled in the art from consideration of the specification and practice of the embodiments of the invention disclosed herein. For examples, while embodiments of the invention have been described herein with reference to a warehouse management (WM) system, embodiments of the invention may be implemented with other systems. For instance, the WM-system could be replaced with a smaller storage management system. Such a storage management system may not have as sophisticated capabilities as a WM system (such as knowing exactly which aisle, column and on which level in a storage building the materials are stored), but may know only that the materials are in a specific storage location (e.g., a storage building). Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

1. A method for managing a return of a product, the method comprising:
receiving a return request for the product;
determining whether the return request is authorized;
issuing, from a first management system, a return authorization number (RAN) for the return request when the return request is determined to be authorized;
creating a record in a second management system for the return request, the record comprising the RAN; and
updating the record in the second management system after the product has been returned.

2. The method of claim 1, wherein the first management system is a customer relationship management (CRM) system.

3. The method of claim 1, wherein the second management system comprises at least one of a supply chain management (SCM) management system and a warehouse management (WM) system.

4. The method of claim 3, wherein the record is a delivery request.

5. The method of claim 1, wherein the method further comprises communicating information between the first and second management systems utilizing the RAN.

6. The method of claim 1, wherein the method further comprises providing a shipping label in response to approving the return request, the shipping label comprising the RAN.

7. The method of claim 1, wherein the return request is for a quantity of the product greater than one.

8. The method of claim 7, wherein the method further comprises splitting the record in the second management system into a plurality of new records with the RAN when less than all of the quantity is received.

9. A method for managing a product return, the method comprising:
authorizing a request from a customer to return a product;
creating at least one record in each of a plurality of management systems when the request for the product return is authorized;
assigning a unique identifier to the product return;
associating the unique identifier with each record corresponding the product to be returned;
exchanging information regarding the product return between the plurality of management systems utilizing the unique identifier.

10. The method of claim 9, wherein the plurality of management systems comprises at least one of a customer relationship management (CRM) system, a supply chain management (SCM) system and a warehouse management (WM) system.

11. The method of claim 10, wherein the plurality of management systems comprises the warehouse management (WM) system.

12. The method of claim 11, wherein the plurality of management systems comprises a logistics, execution and shipping (LES) management system.

13. A method for managing a product return, the method comprising:
assigning at least one return authorization number (RAN) to the product return;
creating in a first database a return authorization record for the product return, the return authorization record comprising the RAN;
creating, in a second database, a warehouse record for the product return, the pending delivery record comprising the RAN; and
updating the return authorization and the pending delivery records using the RAN.

14. The method of claim 13, wherein the return authorization record comprises a plurality of return authorization items.

15. The method of claim 14, wherein each return authorization item comprises a unique RAN.

16. The method of claim 14, wherein the warehouse record comprises a plurality of pending delivery items, each of the pending delivery items being created for at least one of the return authorization items.

17. The method of claim 13, wherein the second database is a warehouse management (WM) system.

18. The method of claim 13, wherein the return authorization record further comprises a product type and a quantity.

19. The method of claim 13, further comprising creating a shipping label based on the return authorization record and communicating the shipping label to a customer.

20. A method for managing a product return, the method comprising:
indexing a record in a first database for a product return using at least one unique identifier;
creating a record for the product return in a second database, the record in the second database comprising the unique identifier; and
exchanging, between the first and second databases, information related to the product return, wherein each item of exchanged information is identified by the unique identifier.

21. A computer readable medium containing instructions for carrying out a method for managing a product return, the method comprising:
creating a record in a customer relationship management (CRM) system for a product return using at least one return authorization number;
creating a record for the product return in a warehouse management (WM) system using the return authorization number; and
exchanging between the management systems information related to the product return, wherein each item of exchanged information is identified by the return authorization number.

22. The method of claim 21, wherein the record in the CRM system is a return authorization record.

23. The method of claim 21, wherein the record in the WM system is a pending delivery record.

24. A computer readable medium containing instructions for carrying out a method, the method comprising:
assigning a return authorization number (RAN) to an approved product return;
creating in a first database a return authorization record for the approved product return, the return authorization record comprising the RAN;
creating, in a second database, a pending delivery record comprising the RAN; and
updating the return authorization and the pending delivery records using the RAN.

25. The method of claim 24, wherein the return authorization record comprises a plurality of return authorization items.

26. The method of claim 25, wherein each return authorization item comprises a return authorization number.

27. The method of claim 25, wherein a pending delivery item is created for each return authorization item.

28. The method of claim 24, wherein the second database is a warehouse management database.

29. The method of claim 24, wherein the return authorization record further comprises a product type and a quantity.

30. The method of claim 24, further comprising creating a shipping label based on the return authorization record and communicating the shipping label to a customer.

31. A computer readable medium containing instructions for carrying out a method for managing a product return, the method comprising:
authorizing a request from a customer to return a product;
creating at least one record in each of a plurality of management systems for handling the product return;
assigning a unique identifier to the product return;
associating the unique identifier with each record corresponding to the product to be returned; and
exchanging information regarding the product return between the plurality of management systems utilizing the unique identifier.

32. A system for managing a return of a product, the method comprising:
a first database configured to receive a return request for the product, and to generate a first record comprising a return authorization number (RAN) for the product if the return request is authorized;
a second database, in communication with the first database, configured to create a second record corresponding to the return, the second record comprising the RAN; and
wherein the first and second database are each configured to exchange information regarding the return utilizing the RAN.

33. The system of claim 32, wherein the first record is a return authorization record.

34. The system of claim 33, wherein the return authorization record comprises a plurality of return authorization items, each corresponding to a unique RAN.

35. The system of claim 32, wherein the second record is a pending delivery record.

36. The system of claim 35, wherein the pending delivery comprises a plurality of pending delivery items each corresponding to a return authorization item.

37. The system of claim 32, wherein a quantity of the returned item is greater than one.

38. The system of claim 37, wherein the first database is configured to split the first record when not all of the quantity is returned.

39. The system of claim 37, wherein the second database is configured to split the second record when not all of the quantity is returned.

40. A system for managing a product return, the method comprising:
a computer configured to assign a return authorization number (RAN) to a product return;
a plurality of databases, each configured to receive the RAN and to create at least one record corresponding to the product return, wherein each record corresponding to the return item is uniquely associated with the RAN.

41. A system for managing a product return, the method comprising:
a first computer comprising a user interface for receiving a return request from a customer, creating a first record comprising a return authorization number (RAN), and transmitting to the customer an authorization for a product return comprising the RAN;
a second computer, in communication with the first computer, configured to receive the RAN, and to create, upon receipt of the return authorization, a record in a database comprising the RAN.

42. The system of claim 41, wherein the user interface comprises a web site.

43. The system of claim 42, wherein a customer submits a return request via the web site.

44. The system of claim 42, wherein the first computer creates a shipping label and transmits the shipping label to a customer via the web site.

45. The system of claim 41, wherein the first and second computers communicate using an EDI.

46. The system of claim 41, wherein the first and second computers communicate using a BAPI.

47. The system of claim 41, wherein the first and second computers communicate using R/3 information objects.
